(19) United States
(12) Patent Application Publication
(10) Pub. No.: US 2026/0271952 A1
(43) Pub. Date: Sep. 17, 2026

(54) PLANT-BASED CHICKPEA MILK

(71) Applicant: Tate & Lyle Solutions USA LLC, Hoffman Estates, IL (US)

(72) Inventors: Mackenzie May Hansen, Hoffman Estates, IL (US); Zheng You, Hoffman Estates, IL (US); Jacob Michael Durbin, Hoffman Estates, IL (US); Mark Gerald Robert, Hoffman Estates, IL (US)

(21) Appl. No.: 19/168,583

(22) PCT Filed: Mar. 28, 2024
(86) PCT No.: PCT/US2024/021875

§ 371 Date: Sep. 24, 2025

Related U.S. Application Data
(60) Provisional application No. 63/456,045, filed on Mar. 31, 2023.

(51) Int. Cl. A23C 11/10; A23L 11/60; A23L 33/185

(52) U.S. Cl. CPC A23C 11/103; A23L 11/60; A23L 33/185; A23C 2220/10

(57) ABSTRACT

A composition including a source of starch; and chickpea protein isolate, chickpea protein concentrate, or combination thereof is provided. The source of starch may be chickpea flour and/or oat flour. The composition may include a consumable liquid, e.g. water, to provide a chickpea milk that may be used in place of a traditional dairy milk. The composition may be in the form of a dry blend that a consumer can reconstitute with a consumable liquid, e.g. water, to provide a chickpea milk. A method of making the composition is also provided. The method may include a step of combining: a consumable liquid; a source of starch; optionally, at least one edible plant-derived lipid and chickpea protein isolate, chickpea protein concentrate, or combination thereof. The method may include a step of subjecting the composition to enzyme treatment to provide a reduced viscosity composition.

### CROSS-REFERENCE TO RELATED APPLICATION

This application claims priority to U.S. Provisional Application No. 63/456,045, filed 31 Mar. 2023, the entire disclosure of which is incorporated herein by reference for all purposes.

### FIELD OF THE INVENTION

The present disclosure relates to plant-based milks.

### BACKGROUND

In recent years there has been a surge of consumer interest in plant-based milk products produced by combining dry plant-based flours and proteins with water, intended to be used in place of traditional dairy milk. Such products desirably have a similar mouthfeel to dairy milk. This means that they should have a viscosity and smoothness akin to traditional dairy milk. Optionally, such plant-based milks may be formulated to have similar protein and/or fat contents as dairy milk. Legumes, such as chickpeas, are an attractive source of plant-based flour and proteins for such milks. A challenge to making such products from chickpea protein and chickpea flour blended into water is the unacceptably high viscosity and gritty mouthfeel when enough of the chickpea product is added to water to arrive at the desired protein level. Another difficulty to overcome is the lack of stability of these plant-based milks. For example, they may settle over time, which presents a storage problem. Such plant-based milks may also thicken over time due to starches in the flour, which also presents a storage problem, in addition to resulting in an unpleasantly high-viscosity product.

Previous efforts to produce such plant-based milks are summarized as follows.

CN104255931B relates to a chickpea milk beverage and its preparation utilizing an alpha-glucosaccharase enzyme inhibition method.

CN110200079A relates to chickpea acidified milks and preparation method thereof.

WO 2016/172570 A1 relates to a non-dairy substitute that can be produced from comparatively high starch legumes, such as chickpeas and adzuki beans.

WO 2021/214779 A1 relates to a non-dairy, chickpea-based alternative milk that does not curdle when added to coffee.

US 2013/0196028 A1 relates to a chickpea soluble fraction enriched with nutritional components and a method of producing same.

US 2016/0309732 A1 relates to a non-dairy substitute produced from comparatively high starch legumes, such as chickpeas and adzuki beans.

US 2022/0022495 A1 relates to a plant protein-containing liquid composition that is not aggregated and/or solidified by an acid.

A need remains for a non-dairy plant milk based on chickpea that has a desirably smooth mouthfeel, low viscosity and excellent storage stability.

### SUMMARY

The present disclosure provides a plant-based chickpea milk beverage as an alternative to dairy milk for consumers with varying dietary preferences. The product provides mouthfeel, thickness, and smoothness akin to dairy milk while also delivering equivalent nutritional protein contents and calcium fortification. Chickpeas are considered a rising star in next-generation plant proteins. They are accepted for their good nutrition, are a nitrogen fixing crop, and have a desirable lack of allergenicity issues. The composition and process detailed in this disclosure provide a plant-based milk alternative having low viscosities and equivalent protein contents to conventional dairy milks. According to an embodiment, an aqueous ready to drink chickpea composition is provided. Alternatively, a dry chickpea composition may be provided to create a ready-to-mix chickpea milk powder that may be reconstituted in water by consumers or used to formulate dairy-alternative food products in place of dry dairy ingredients. A plant-based beverage that serves as an alternative to dairy milk, providing similar sensory mouthfeel and smoothness characteristics as well as equal nutritional protein quantities is therefore provided.

The composition and method of making thereof provides a low viscosity beverage with smooth mouthfeel, suitable as a dairy milk replacement for drinking, addition to tea, coffee or hot chocolate, for eating with cereal or oatmeal, or for baking and preparation of icings or glazes, for example.

A composition including a consumable liquid; a source of starch; and chickpea protein isolate, chickpea protein concentrate, or combination thereof is provided.

A composition including a source of starch; and chickpea protein isolate, chickpea protein concentrate, or combination thereof is also provided.

A method of preparing a composition is also provided. The method includes the steps:

Combining a consumable liquid; a source of starch; optionally, at least one edible plant-derived lipid, and chickpea protein isolate, chickpea protein concentrate, or combination thereof to provide a chickpea protein and starch composition. This chickpea protein and starch composition has an enzymatically untreated viscosity. The enzymatically untreated viscosity is measured after standing for 12 hours at 4° C. and is measured with a Brookfield DV2T Viscometer for beverages at 4° C., with spindle #1, readings taken after 30 seconds at 100 rpm, and torque in the range of 15-85%.

According to some embodiments, the method may further include a step of combining an enzyme with the chickpea protein and starch composition having an enzymatically untreated viscosity. The enzyme is capable of acting on the starch present in the source of starch under enzymatic conditions to hydrolyze at least a portion of the starch present in the source of starch into sugar. According to an embodiment, the method includes a step of allowing the enzyme to hydrolyze at least a portion of the starch present in the source of starch into sugar at the enzymatic conditions to provide a chickpea protein and starch composition having a reduced viscosity. The reduced viscosity is measured after allowing the enzyme to hydrolyze at least a portion of the starch present in the source of starch into sugar and after standing for 12 hours at 4° C., as measured with a Brookfield DV2T Viscometer for beverages at 4° C., with spindle #1, readings taken after 30 seconds at 100 rpm, and torque in the range of 15-85%. The reduced viscosity is lower than the enzymatically untreated viscosity. Importantly, the reduced viscosity is understood to be reduced compared to a similar composition that has not undergone enzyme treatment, but which has been subjected to a similar processing regimen, i.e., pasteurization, homogenization, etc. if those steps have been done on the enzyme-treated composition.

### DETAILED DESCRIPTION

Chickpea Protein Isolate: As used herein, the term “chickpea protein isolate” means a refined chickpea protein product containing at least 80% by weight of chickpea protein on a moisture-free basis. According to some embodiments, the chickpea protein isolate is enriched with a variety of food ingredients, such as, but not limited to, additional non-chickpea protein and minerals, flavorings, flavor masking ingredients, which are either indigenous or externally supplemented. According to some embodiments, the chickpea protein isolate may comprise at least 80, 85, 90 or at least 95 weight percent of chickpea protein by total weight of the chickpea protein isolate on a moisture-free basis. The chickpea protein isolate may be defatted, meaning it has undergone further processing to remove at least some fat. The chickpea protein isolate may be included in the composition disclosed herein in an amount to provide the desired level of protein in the composition. According to an embodiment, the chickpea protein isolate may include 0-10 wt % water, 0-10 wt % ash; 80-99 wt % chickpea protein; 1-20 weight % carbohydrate. The carbohydrate components may be present in the following amounts, based on a total weight of the chickpea protein concentrate on a moisture-free basis: soluble fiber 5-20 wt %; insoluble fiber 5-20 wt %; total sugar 0.5-5 wt %; other carbohydrate: 0-2 wt %.

Chickpea Protein Concentrate: As used herein, the term “chickpea protein concentrate” means a refined chickpea protein product containing at least 40% by weight of chickpea protein on a moisture-free basis. According to some embodiments, the chickpea protein concentrate may comprise at least 40, 45, 50, 55, 60, 65, 70, or at least 75% by total weight of chickpea protein concentrate on a moisture free basis. According to some embodiments, the chickpea protein concentrate is enriched with a variety of food ingredients, such as, but not limited to, protein and minerals, flavorings, flavor masking ingredients, which are either indigenous or externally supplemented. The chickpea protein concentrate may be defatted, meaning it has undergone further processing to remove at least some fat. The chickpea protein concentrate may be included in the composition disclosed herein in an amount to provide the desired level of protein in the composition. According to an embodiment, the chickpea protein concentrate may include 0-10 wt % water, 0-10 wt % ash; 25-79 wt % protein; from 20-40 weight % carbohydrate. The carbohydrate components may present in the following amounts, based on a total weight of the chickpea protein concentrate: soluble fiber 5-20 wt %; insoluble fiber 5-20 wt %; total sugar 0.5-5 wt %; other carbohydrate: 0-2 wt %.

According to some embodiments, the terms “chickpea protein concentrate” and “chickpea protein isolate” may be used interchangeably and are intended to differentiate from chickpea products that have not been processed to increase their protein content to a level above that of as-is chickpeas.

Starch: As used herein the term “starch” refers to a polymer formed of linked anhydro-α-D-glucose units. It may have either a mainly linear structure (amylose) or a branched structure (amylopectin).

Protein: As used herein the term “protein” refers to a polymeric form of amino acids of any length, i.e., comprising 2 or more amino acids.

Chickpeas may be referred to as chickpea, garbanzo, or Bengal gram (Cicer arietinum).

All percents are weight percent unless stated otherwise.

### Compositions:

Liquid Composition: A composition including a consumable liquid; a source of starch; and chickpea protein isolate, chickpea protein concentrate, or combination thereof is provided. This composition may be suitable as a beverage. According to an embodiment, the composition may have a pH of from 4.6-8. For example, the composition may have a pH of at least 4.6, 5, 5.5, 6, 6.5, 7, or at least 8. For example the composition may have a pH of at most 8, 7.5, 7, 6.5, 6, 5.5, or at most 5.

According to an embodiment, this liquid composition may have a starch range from 0.01 to 1 wt %, chickpea protein from 0.01 to 6 wt %, plant-based fat from 0 to 6 wt %, based on the total composition weight including the liquid. Such levels of starch, protein and fat are those as would be appropriate for a milk alternative beverage, with chickpea protein and starch contents most strongly influencing viscosity. According to another embodiment, the quantity of chickpea protein could be as high as possible to maintain viscosity, and plant-based fat content could also be higher, although that isn't commonly found with milk-substitute products. As would be appreciated by a skilled person, the amounts of chickpea protein, starch, and plant-based fat may be adjusted to arrive at a beverage having the desired nutritional profile. According to an embodiment, such a liquid composition may include one or more of the following additional ingredients (all wt % on a dry basis except as noted): soluble fiber (0.05-10.0 wt %); stevia leaf extract (0.005 wt % or more-no maximum usage restrictions for USA GRAS); steviol glycosides (0.005 wt % or more-no maximum usage restrictions for USA GRAS); monkfruit extract (0.005 wt % or more-no maximum usage restrictions for USA GRAS); salt (0.001-5 wt %); gellan gum (0.001-3 wt %); calcium carbonate (0.05-2 wt %); plant-based oils or fats (0.5-10 wt % based on the total weight including liquid); liquid flavors and maskers (0.005-5 wt % based on the total weight including liquid.) According to an embodiment, the liquid composition includes 4 wt % or more of fiber (soluble or insoluble) on a total weight basis. According to an embodiment, the liquid composition may include from 0.05 to 10 wt % of chickpea protein present in the chickpea protein concentrate or chickpea protein isolate or combination thereof and from 0.05 to 10 wt % of the starch present in the source of starch. According to an embodiment, the liquid composition may include from 0.05 to 10 wt % of the chickpea protein present in the chickpea protein isolate, chickpea protein concentrate, or combination thereof and from 0.05 to 10 wt % of the starch present in the source of starch. According to an embodiment the liquid composition may have a viscosity of less than 60 cPs after standing for 12 hours at 4° C., as measured with a Brookfield DV2T Viscometer for beverages at 4° C., with spindle #1, readings taken after 30 seconds at 100 rpm, and torque in the range of 15-85%.

Dry Blend Composition: A composition including a source of starch; and chickpea protein isolate, chickpea protein concentrate, or combination thereof is also provided. This dry blend may be reconstituted with a consumable liquid, such as water, to provide an aqueous beverage, for example. Other consumable liquids, as disclosed herein, are suitable to reconstitute the dry blend.

According to an embodiment, such a dry blend may include one or more of the following additional ingredients (all wt % on a dry basis): soluble fiber (0.05-10.0 wt %); stevia leaf extract (0.005 wt % or more-no maximum usage restrictions for USA GRAS); steviol glycosides (0.005 wt % or more-no maximum usage restrictions for USA GRAS); monkfruit extract (0.005 wt % or more-no maximum usage restrictions for USA GRAS); Salt (0.001-5 wt %); gellan gum (0.001-3 wt %); calcium carbonate (0.05-2 wt %). According to an embodiment, the dry composition may include 4 wt % or more of fiber (soluble or insoluble) on a dry basis.

According to an embodiment, the dry blend may further be combined with at least one consumable liquid, such that the resulting composition has a viscosity of less than 60 cPs after standing for 12 hours at 4° C., as measured with a Brookfield DV2T Viscometer for beverages at 4° C., with spindle #1, readings taken after 30 seconds at 100 rpm, and torque in the range of 15-85%. According to some embodiments, the viscosity of the resulting composition may be 60 cPs or less, 55 cPs or less, 50 cPs or less, 45 cPs or less, 40 cPs or less, 35 cPs or less, 30 cPs or less, 25 cPs or less, or less than 20 cP.

### Chickpea Protein Concentrate or Chickpea Protein Isolate:

According to some embodiments, the liquid composition may include from 0.05-10 wt % of chickpea protein concentrate or chickpea protein isolate, or combination thereof, by weight of the liquid composition. For example, the liquid composition may include at least 0.05, 0.1, 0.5, 1, 1.5, 2, 2.5, 3, 3.5, 4, 4.5, 6, 6.5, 7, 7.5, 8, 8.5, 9 or at least 9.5 wt % of chickpea protein concentrate or chickpea protein isolate, or combination thereof, by weight of the liquid composition. For example, the liquid composition may include at most 10, 9.75, 9.5, 9.25, 9, 8.75, 8.5, 8.25, 8, 7.75, 7.5, 7.25, 7, 6.75, 6.5, 6.25, 6, 5.75, 5.5, 5.25, 5, 4.75, 4.5, 4.25, 4, 3.75, 3.5, 3.25, 3, 2.75, 2.5, 2.25, 2, 1.75, 1.5, or at most 1 wt % of chickpea protein concentrate or chickpea protein isolate, or combination thereof, by weight of the liquid composition.

According to some embodiments, the dry blend composition may include from 2 to 97 wt % of chickpea protein concentrate or chickpea protein isolate, or combination thereof, based on the dry weight of the dry blend composition. For example, the dry blend composition may include at least 2, 3, 4, 5, 7, 10, 15, 20, 25, 30, 35, 40, 45, 50, 55, 60, 65, 70, 75, 80, 85, 90, or at least 95 wt % of chickpea protein concentrate or chickpea protein isolate or combination thereof, based on the dry weight of the dry blend composition. For example, the dry blend composition may include at most 97, 95, 90, 85, 80, 75, 70, 65, 60 55, 50, 45, 40, 35, 30, 25, 20, 15, 10, 9, 8, 7, 6, 5, 4, or at most 3 wt % of chickpea protein concentrate or chickpea protein isolate or combination thereof, based on the dry weight of the dry blend composition.

### Source of Starch:

The source of starch provides starch that may be hydrolyzed by an enzyme to provide hydrolyzed starch. Thus, the product after enzyme treatment contains hydrolyzed starch (starch present in the source of starch that has been hydrolyzed by the enzyme). In certain embodiments, the starch present in the source of starch may not have been completely hydrolyzed by the enzyme treatment and therefore the product may contain both hydrolyzed and unhydrolyzed starch. Before enzyme treatment, the composition may contain unhydrolyzed starch only.

Any flour with a high level of starch may be used as the source of starch. Non-limiting examples of starch sources include chickpea flour, oat flour, wheat flour, corn flour, potato flour, tapioca, dent corn starch, sago starch, starches that have undergone partial hydrolysis, and combinations thereof. The flours may or may not have had the bran removed.

According to an embodiment the source of starch may include chickpea flour, oat flour or a combination thereof. According to an embodiment, the source of starch is chickpea flour. According to an embodiment, the chickpea flour includes about 50 wt % starch or more on a dry solids basis and includes 30 wt % or less of protein and fiber components.

According to an embodiment a liquid ‘milk’ alternative beverage composition intended to mimic the nutritional profile of a dairy milk may include below 1 wt % of starch present in the source of starch, less than 6 wt % of chickpea protein present in the chickpea protein isolate, chickpea protein concentrate, or combination thereof, less than 6 wt % of plant-based fat or lipid. The protein and starch contents may influence the viscosity of such a composition. According to an embodiment, the quantity of chickpea protein present in the chickpea protein concentrate or chickpea protein isolate or combination thereof could be as high as possible to maintain the desired viscosity, and the fat content could also be higher than that found in traditional dairy milk.

According to an embodiment, the composition includes 0.005 to 200 grams of the starch present in the source of starch per gram of the chickpea protein present in the chickpea protein isolate or chickpea protein concentrate or combination thereof. According to some embodiments, the composition includes at least 0.005, 0.01, 0.05, 0.1, 0.3, 0.5, 1.0, 5.0, 10, 15, 20, 30, 50, 75, 100, or 150 grams of the starch present in the source of starch per gram of the chickpea protein present in the chickpea protein isolate or the chickpea protein concentrate, or combination thereof. According to some embodiments, the composition includes at most 200, 190, 175, 150, 125, 100, 90, 80, 70, 60, 50, 40, 30, 20, 10, 9, 8, 7, 6, 5, 4, 3, 2, 1, 0.5, 0.25, or at most 0.1 gram of starch present in the source of starch per gram of chickpea protein present in the chickpea protein concentrate or the chickpea protein isolate, or combination thereof in the composition.

According to an embodiment, the liquid composition may include from 0.05 to 10 wt % of the hydrolyzed starch or any remaining starch (not hydrolyzed) from the source of starch based on a total weight of the composition.

### Enzyme:

The enzyme is capable of acting on the starch under enzymatic conditions to hydrolyze at least a portion of the starch present in the source of starch into sugar. Any enzyme capable of hydrolyzing granular and/or gelatinized starch to sugar(s) is suitable for use herein. For example, alpha, beta, or gamma amylases are all suitable. Combinations of enzymes that are capable of hydrolyzing the starch from the source of starch are also suitable. Without wishing to be bound by any particular theory, the enzyme may break down the starch in the source of starch and thus may reduce the viscosity of the composition. According to an embodiment, the enzyme may be capable of acting on granular starch from the source of starch that was not gelatinized. According to an embodiment, the enzyme may be capable of acting on a gelatinized starch from the source of starch. The enzyme present in the composition (either liquid or the dry blend) may be active or inactivated.

The use level of the enzyme may be varied as appropriate to achieve the desired hydrolysis of the starch in the source of starch to sugar to provide the viscosity reduction. As is known in the art, the reaction time and temperature may be varied together with amount of enzyme to provide the desired hydrolysis, which is reflected in the reduction in viscosity. The cost of the enzyme may be offset by longer or shorter reaction times According to an embodiment, 1 g enzyme per 1 kg of starch present in the source of starch may be utilized. It is understood that this means the amount of such starch that is present in the composition prior to the hydrolysis reaction. According to another embodiment, the dosage of the enzyme could be reduced to 0.1 gm of enzyme per kg of starch, and increased until it is not cost effective. An upper limit may be as much as 10 g of enzyme per kg of starch. For example, the composition may include at least 0.1, 0.2, 0.3, 0.4, 0.4, 0.6, 0.7, 0.8, 0.9, 1, 2, 3, 4, 5, 6, 7, 8, or at least 9 gm enzyme per kg of starch present in the source of starch. For example, the composition may include at most 10, 9.5, 8.5, 8, 7.5, 7, 6.5, 6, 5.5, 5, 4.5, 4, 3.5, 3, 2.5, 2, 1.9, 1.8, 1.7, 1.6, 1.5, 1.4, 1.3, 1.2, 1.1 or at most 1 gram of enzyme per kg of starch present in the source of starch.

If necessary, a suitable amount of a source of calcium may be included in the composition if needed for enzymatic activity. For example, according to some embodiments, the composition may include at least 0.0001, 0.0005, 0.001, 0.005, 0.01, 0.05, 0.1, 0.5, 1, 1.5, 2, or at least 2.5 wt % of a source of calcium, such as calcium carbonate.

### Consumable Liquid:

Any consumable liquid may used in the composition, either as the liquid in the liquid composition, or to reconstitute the dry composition. Non-limiting examples include water, fruit juice, coffee, tea, carbonated water, carbonated beverages, alcoholic beverages, soft drinks, etc.

### Edible Plant-Derived Lipid:

Any source of plant-derived lipid (fat) could be used, especially liquid fats, i.e. oils. Non-limiting examples of suitable oils include coconut oil, algae oil, avocado oil, canola oil, castor oil, corn oil, cottonseed oil, flax oil, grapeseed oil, hemp oil, jatropha oil, jojoba oil, mustard oil, dehydrated castor oil, palm oil, palm stearin, palm kernel oil, rapeseed oil, safflower oil, soybean oil, sunflower oil, tall oil, olive oil, linoleic oil, peanut oil, or mixtures thereof. Fats that are solid at ambient or cooler conditions may also be used. For example, hydrogenated and partially hydrogenated oils; such as hydrogenated or partially hydrogenated coconut oil; hydrogenated or partially hydrogenated palm oil; or hydrogenated or partially hydrogenated palm kernel oil; or combinations thereof may be used. Such fats (liquids or solid) may be used in a liquid composition that is intended to be homogenized. If lipids (fats) are included, the composition may also include an emulsifier that is suitable to provide a stable emulsified composition.

The lipid (fat) could be added at up to 50% by weight of the composition (either liquid or dry). If a lipid is included in the liquid composition, the composition may be emulsified (homogenized) such that the fat does not separate out over time. Such emulsification may be achieved by a homogenization process, such that lipid is physically broken down into small droplets to form a stable emulsion. According to another embodiment, an edible emulsifier may be added to provide a stable emulsion. The emulsion may be water-in-oil, or oil-in-water. If less than 50% of the lipid is added, the emulsion would be an oil-in-water emulsion. If more than 50% of lipid is added to an aqueous composition, the emulsion would be a water-in-oil emulsion. Emulsification would be required to disperse fat throughout the continuous water phase. Without wishing to be bound by any particular theory, the mixture of the source of starch (e.g. chickpea flour) and the chickpea protein isolate, chickpea protein concentrate, or combination thereof may also have some emulsification ability without further processing such as homogenization and/or addition of an emulsifier.

For a milk alternative product, fat content below 6 wt % is appropriate. According to an embodiment, the fat may also be higher than 6 wt %, based on a total weight of the composition. According to an embodiment, the amount of fat in the liquid composition may be from 0 to 4 wt % based on a total weight of the liquid composition. For example, the liquid composition may include at least 0.1, 0.5, 1, 1.25, 1.5, 1.75, 2, 2.5, 3, 3.5, 4, 4.5, or at least 5.5 wt % of fat, based on total weight of the liquid composition. For example, the liquid composition may include at most 6, 5.75, 5.5, 5.25, 5, 4.75, 4.5, 4.25, 4, 3.75, 3.5, 3.25, 3, 2.75, 2.5, 2.25, 2, 1.5, 1 or at most 5 wt % of fat, based on total weight of the liquid composition.

According to an embodiment, the dry blend composition may include from 0 to 50 wt % of fat, based on the dry weight of the dry blend composition. For example, the dry blend composition may include 0 wt %, or at least 1, 2, 3, 4, 5, 10, 15, 20, 25, 30, 35, 40 or at least 45 wt % of fat, based on the dry weight of the dry blend composition. For example, the dry blend composition may include at most 50, 45, 40, 35, 30, 25, 20, 15, 10, 5, or at most 2 wt % of fat, based on the dry weight of the dry blend composition.

### Fiber:

The dry or wet composition may also include soluble or insoluble fiber. The amount of fiber may range from 0 to up to 50% by weight, on dry basis, or from 0 to 20 wt % on a dry basis. According to an embodiment, the dry or wet composition may include 4 wt % or more of fiber, either soluble or insoluble or a combination thereof, on either a dry basis or based on a total eight of the composition. For example, if present, the composition may include at least 1, 2, 3, 4, 5, 6, 7, 8, 9, 10, 15, 20, 25, 30, 35, 40, or at least 50% by weight of fiber, either on a dry basis, or based on a total weight of the composition. For example, the composition may include at most 50, 45, 40, 35, 30, 25, 20, 15, 10, 9, 8, 7, 6, or at most 5% by weight of fiber, either on a dry basis, or based on a total weight of the composition.

The fiber in the dry or wet composition may be from the source of starch used to produce the composition. For example, the fiber may be the fiber that is naturally present in the chickpea flour or oat flour or the chickpea protein concentrate or chickpea protein isolate and thus remains in the composition, since fiber would not be broken down by the enzyme used to hydrolyze the starch present in the source of starch. According to another embodiment, the composition is enriched in soluble and/or non-soluble fiber. Non-limiting examples of such added fiber include inulin, fructooligosaccharides, chicory root, wheat bran, oat bran, corn bran, soluble corn fiber, or combinations thereof.

### Viscosity:

Several analytical methods exist to indicate degradation of starch in this process-amounts of carbohydrates released can be used on a Brix refractometer, or the amount of reducing ends (what is produced when starch is broken into smaller sugars) can be measured by colorimetric assay. In the present disclosure, the viscosity of the composition was used as indirect measure of the hydrolysis of the starch in the composition. In other words, reduction in viscosity measurements may be used as an indirect method indicating starch breakdown. All of viscosities as recited herein are measured after 12 hours standing at 4° C. with a Brookfield DV2T Viscometer for beverages at refrigeration temperature, with spindle #1, readings taken after 30 seconds at 100 rpm, torque in the range of 15-85%.

Suitable viscosities for milk alternative beverages were approximately 60 cPs or less and preferably 50 cPs or less. According to some embodiments, the viscosity of the composition may be 60 cPs or less, 55 cPs or less, 50 cPs or less, 45 cPs or less, 40 cPs or less, 35 cPs or less, 30 cPs or less, 25 cPs or less, or less than 20 cP.

As disclosed herein, the enzymatically untreated viscosity of a composition refers to a viscosity of a composition that has not been subjected to enzyme treatment, but that may have been or has been subjected to heating, pasteurization and/or homogenization. The reduced viscosity of a composition as disclosed herein refers to a viscosity of a composition that has been reduced compared to the enzymatically untreated viscosity of the same composition, subjected to the same processing steps, but which has additionally been subjected to the enzyme treatment disclosed herein.

### Other Ingredients:

Non-limiting examples of other ingredients that may be included in the liquid or dry composition are vitamins/minerals, flavor maskers, flavor modifiers, stabilizers; flavors, sweeteners, preservatives, emulsifiers, viscosity modifiers, thickeners, probiotics, prebiotics, vitamins, minerals, soluble or insoluble fiber, salt, flavor maskers, flavor modifiers, stevia leaf extract, monkfruit extract, calcium carbonate, gums, stabilizers, hydrocolloids, locust bean gums, or combinations thereof.

Examples of thickeners are thickening starches, such as corn, tapioca and potato starches. These thickening starches are understood to be addition to the starch that is present in the source of starch that may comprise at least one of chickpea flour or oat flour. Emulsifying starches may also be included in addition to the starch present in the source of starch. Such emulsifying starches may be added to stabilize an optional consumable plant-derived lipid in the composition.

Liquefied starches (including starches that have undergone partial or complete hydrolysis catalyzed, for example, by acid and/or enzymes such as amylases), dextrins (including maltodextrins), cyclodextrins and the like, or combinations thereof may also be included in the liquid composition or the dry blend composition.

Functional powders may be included in the dry blend to prevent dusting and encourage flowability of the blend composition.

Hydrocolloids may be included in the liquid composition or the dry blend composition. Hydrocolloids may be included to modify the viscosity of the composition. Hydrocolloids are used as thickening or gelling agents. Hydrocolloids are a heterogeneous group of long chain polymers (polysaccharides and proteins) characterized by their property of forming viscous dispersions and/or gels when dispersed in water. Presence of a large number of hydroxyl (—OH) groups markedly increases their affinity for binding water molecules, thus rendering them hydrophilic compounds. Further, they produce a dispersion, which is intermediate between a true solution and a suspension. Non-limiting examples include xanthan, carboxymethylcellulose, methylcellulose, hydroxypropyl methylcellulose, gum arabic, galactomannans (e.g. guar gum, locust bean gum and tara gum), konjac maanan, gum tragacanth, modified starch, agar, K-Carrageenan and i-carrageenan, low methoxy pectin, high methoxy pectin, gellan gum, gelatin, or alginate. Starch also may act as a hydrocolloid until it has been hydrolyzed, as disclosed here.

Non-limiting examples of sweeteners include sweet saccharides (e.g., sucrose, fructose, allulose), natural and synthetic high intensity sweeteners (e.g. monkfruit extract or derivatives thereof, stevia extract or derivatives thereof, sucralose), and naturally occurring, bulking sugar alcohols (e.g. erythritol, mannitol, sorbitol, xylitol, lactitol, isomalt, maltitol).

### Uses of the Liquid Composition or the Dry Blend Composition:

The liquid composition or the dry blend composition, are great for use in savory dishes because of their neutral flavor. One may add either to coffee or tea and use them in place of regular (traditional dairy) or plant-based alternative milk in any recipe. One may also use the liquid composition or the dry blend composition in coffees or to make other dairy-alternative products such as plant-based yogurts or frozen desserts. At their most simple, the liquid composition or the dry blend composition reconstituted with a liquid make an excellent warm or cold drink.

### Methods:

The composition is prepared by combining:
a consumable liquid;
a source of starch;
optionally, at least one edible plant-derived lipid; and
chickpea protein isolate, chickpea protein concentrate, or combination thereof;
to provide a chickpea protein and starch composition having an enzymatically untreated viscosity. The enzymatically untreated viscosity is measured after standing for 12 hours at 4° C., as measured with a Brookfield DV2T Viscometer for beverages at 4° C., with spindle #1, readings taken after 30 seconds at 100 rpm, and torque in the range of 15-85%.

The blending or combining step may be done using conventional equipment as is known in the art. For example, high shear mixers, planetary mixers, kneaders, three roll mills, multishaft mixers, ribbon paddle blenders, static mixers (together with a pumping system), vertical blenders, or tumble blenders, are all suitable. According to some embodiments, the combining step may be done in more than one operation. For example, the dry ingredients may be combined in a tumble blender and then the liquid component may be added in another step in a planetary mixer for example.

According to another embodiment, an enzyme may be combined with the chickpea protein and starch composition having an enzymatically untreated viscosity. The enzyme, as described above, is capable of acting on the starch present in the source of starch under enzymatic conditions to hydrolyze at least a portion of the starch present in the source of starch into sugar. The enzyme may be allowed to hydrolyze at least a portion of the starch present in the source of starch into sugar at the enzymatic conditions; to provide a chickpea protein and starch composition having a reduced viscosity. The reduced viscosity is measured after allowing the enzyme to hydrolyze at least a portion of the starch present in the source of starch into sugar and after standing for 12 hours at 4° C., as measured with a Brookfield DV2T Viscometer for beverages at 4° C., with spindle #1, readings taken after 30 seconds at 100 rpm, and torque in the range of 15-85%. The reduced viscosity is lower than the enzymatically untreated viscosity. As discussed above, the enzymatically untreated viscosity refers to a viscosity of a composition that has not been subjected to enzyme treatment, but that may have been subjected to heating, pasteurization and/or homogenization. The reduced viscosity as disclosed herein means a viscosity that is reduced compared to the enzymatically untreated viscosity of the same composition, subjected to the same processing steps, but which has been subjected to the enzyme treatment disclosed herein. According to an embodiment, the reduced viscosity is 60 cPs or less, preferably 50 cPs or less. The reduced viscosity may be 55 cPs or less, 50 cPs or less, 45 cPs or less, 40 cPs or less, 35 cPs or less, 30 cPs or less, 25 cPs or less, or less than 20 cPs.

According to an embodiment, the enzyme may be deactivated when subjected to deactivation conditions. According to an embodiment, the enzyme (deactivated or active) may be removed from the composition. According to another embodiment, the composition may be subjected to a step of homogenization. According to an embodiment, the composition may undergo a step of removing at least some of the consumable liquid.

### Enzyme Treatment Conditions:

According to an embodiment, the enzyme may be added at a level of 1 g enzyme per 1 kg of starch present in the source of starch in the composition that includes the chickpea protein and the source of starch. The dosage of the enzyme may be reduced to 0.1 g of enzyme per 1 kg of starch from the source of starch, and increased until it is not cost effective. According to some embodiments, the enzyme may be present at from 0.01 to 100 grams, preferably 0.5 to 1.5 grams of the enzyme per kg of starch from the source of starch in the composition The effective temperature range of the enzyme treatment may vary from 20° C. to 70° C. According to some embodiments, the enzyme treatment temperature may be selected to avoid unwanted gelatinization of the starch from the source of starch. The temperature of the enzyme treatment may also be selected to avoid deactivation of the enzyme. The temperature of the enzyme treatment step may range from 10° C. to 100° C., preferably from 10° C. to 70° C. For example, the temperature of the enzyme treatment may be at least 10, 15, 20, 25, 30, 35, 40, 45, 50, 55, 60, 65, 70, 75, 80, 85, or at least 90° C. For example, the temperature of the enzyme treatment may be at most 100, 95, 90, 85, 80, 75, 70, 65, 60, 55, 50, 45, 40, 35, or at most 30° C.

According to an embodiment, the pH of the enzyme treatment may be from 3-13, preferably 3-9, or more preferably at pH 4-9. For example, the pH may be at least 3, 4, 5, 6, 7, 8, or at most 9. For example, the pH of the enzyme treatment may be at most 13, 12, 11, 10, 9, 8, 7, 6, 5, or at most 4.

The time of the enzyme treatment may be varied according to the type and amount of enzyme as well as the temperature of the enzyme treatment step. For example, the enzyme treatment may be a minimum of 10 minutes of time for the reaction. The time of the enzyme treatment may be increased until it is no longer cost effective or efficient. The time may be varied to suit the desired level of starch hydrolysis to achieve the target viscosity. For example the time of the enzyme treatment may be at least 10, 15, 20, 25, 30, 35, 40, 45, 50, 55, 60, 75, 90, 105, 120, 135, 150, 165, 180, 195, 210, or at least 225 minutes. For example the time of the enzyme treatment may be at most 240, 225, 210, 195, 180, 165, 150, 135, 120, 105, 90, 75, 60, 55, 50, 45, 40, 35 or at most 30 minutes.

### Deactivating Enzyme/Pasteurization:

When the starch borne by the source of starch has been sufficiently hydrolyzed (i.e., the desired viscosity is achieved), the enzyme activity can be stopped by increasing the temperature above 70° C., and preferably above 90° C. Time at temperature is inversely related to the effectiveness of deactivation of the enzyme. Lower temperatures require more time than higher temperatures for effective deactivation of the enzyme. For example, the enzyme may be deactivated after 10 minutes at 90° C., 20 minutes at 85° C., 3 hours at 75° C. According to an embodiment, the enzyme may be deactivated by a temperature of at least 125° C. for at least one second, preferably 100° C. for at least two minutes, more preferably at least 90° C. for at least 10 minutes. As is known in the art, typical pasteurization conditions are sufficient to deactivate the enzyme, and according to an embodiment, the enzyme is deactivated by subjecting the composition to a step of pasteurization.

### Homogenizing:

The homogenizing step can take place before, during or after enzymatic treatment. The homogenization process involves reducing the size of lipid or solid globules of fat in the composition into minuscule portions that are dispersed evenly throughout the composition. Homogenization may be achieved by pumping the composition through small openings under very high pressure, e.g. 200 bar.

### Drying (Removing Liquid to Form Dry Composition):

In order to produce the dry blend as described here, the liquid composition may be dried. Non-limiting methods of removing the liquid component (usually water) are freeze drying, spray drying, or evaporation using heat and/or reduced pressure. According to some embodiments, some, all or nearly all of the liquid may be removed. If not all of the liquid is removed, a liquid or paste concentrate may be formed, that may be used as-is in certain applications, or that may later be reconstituted to provide a liquid composition.

### Removing Enzyme:

According to an embodiment, the enzyme may be removed from the composition after the enzyme treatment. Non limiting examples of removal of the enzyme include filtration, or chromatography for example. Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

In order that the invention may be more fully understood, the following non-limiting examples are present in way of illustration only.

A nonlimiting example of a suitable chickpea milk includes water (70-99 wt %), chickpea flour (0.05-10.0 wt %), chickpea protein (0.05-10 wt %), soluble fiber (0.05-10.0 wt %), gellan gum (0.005-2.0 wt %), calcium (0.001-3.0 wt %), optionally a starch-cleaving food enzyme (0.0001-5.0 wt %), edible plant-based oil (0.1-20 wt %), and flavors, salts, sweeteners as desired, based on a total weight of the chickpea milk.

The chickpea protein concentrate used in the following Examples has the following composition:

| | g/100 g |
|---|---|
| Moisture | 4.17 |
| ash | 5.04 |
| total fat | 2.055 |
| Protein* | 58.46 |
| Total carb | 30.28 |

The following compositions were prepared generally as follows.
1. Weigh dry ingredients and mix together.
2. Weigh water, heat (75-180° F.| 20° C.-85° C.), transfer to mixer, add liquid oil, begin stirring.
3. Add dry ingredients to liquid portion, mix to combine with moderate agitation until well-dispersed and no clumps are present.
4. If using the enzyme, transfer mixture to kettle and add starch-cleaving food enzyme if using.
5. Heat mixture (80-180° F.| 25° C.-85° C.) and hold at temperature with constant stirring (20-120 minutes)
6. Pasteurize via ultra-high temperature (UHT) treatment (3-4 second hold at 285° F.| 140° C.), followed by homogenization at 200 bar. This treatment is intended to also inactivate the enzyme if an enzyme is present.
7. Collect product and refrigerate for storage.

### Example 1: Composition Made without Enzymatic Treatment and Oat Flour

Table 1 shows the dry blend components for the chickpea milk composition.

TABLE 1

| | | Wt % aqueous |
|---|---|---|
| | Wt % Dry | beverage plus |
| Component | Blend | plant based oil |
| Oat flour (about 60 wt % starch) | 12.76% | 1.2505% |
| Chickpea protein concentrate | 55.51% | 5.4400% |
| (about 60 wt % protein) | | |
| Soluble corn fiber, dry | 25.51% | 2.5000% |
| Salt | 1.22% | 0.1196% |
| Gellan gum | 0.17% | 0.0167% |
| Sweetener | 0.14% | 0.0133% |
| Natural Milk Flavor | 0.51% | 0.0500% |
| Calcium Carbonate | 4.18% | 0.4096% |
| Vanillin (1% solution) | none | 1.46 |
| Flavor masker | none | 0.1 |
| Coconut oil | none | 1.46 |
| Water | none | Balance to 100% |

Results: The fresh product had good flavor (a little beany), good viscosity, smooth mouthfeel.

The above aqueous composition was allowed to stand overnight at 4° C. After standing, the overnight viscosity (Brookfield viscometer, spindle #1, reading after 30 seconds at 100 RPM: approximately 80 cP, which is considered too thick for a milk alternative beverage.

### Example 2: Composition Made with Enzymatic Treatment and Oat Flour

Table 2 shows the chickpea milk composition with enzymatic treatment made as described above. Note that the enzyme is added at 1.1 grams per kg of starch from the flour in the composition. This is the same composition as shown in Table 1, with added enzyme. 15 kg of the mixture contained about 138 grams starch.

TABLE 2

| | | Wt % (except for |
|---|---|---|
| | | enzyme) aqueous |
| | Wt % Dry | beverage plus |
| Component | Blend | plant based oil |
| Oat flour (about 60 wt % starch) | 12.76% | 1.25% |
| Chickpea protein concentrate | 55.51% | 5.4400% |
| (about 60 wt % protein) | | |
| Soluble corn fiber dry | 25.51% | 2.50% |
| Salt | 1.22% | 0.12% |
| Gellan gum | 0.17% | 0.0167% |
| Sweetener | 0.14% | 0.0133% |
| Natural Milk Flavor | 0.51% | 0.0500% |
| Calcium Carbonate | 4.18% | 0.4096% |
| Vanillin (1% solution) | none | 1.46% |
| Flavor masker | none | 0.1% |
| Coconut oil | none | 1.46% |
| Alpha amylase | none | 0.15 gram (1.1 |
| | | grams per kg starch) |
| Water | none | Balance to 100% |

Results: Fresh product had a light flavor and sweetness, light color, smooth mouthfeel, low viscosity.

After standing overnight at 4° C., the viscosity was measured as described above to be 39.3 cPs (average of 3 measurements). The beverage was smooth, had good flavor and a good mouthfeel.

### Example 3: Half Chickpea Protein, Half Sunflower Protein

The same composition as shown in Example 2 was prepared, except that half of the chickpea protein was replaced with sunflower protein to provide a composition having the same total protein content.

Results: The fresh product had a light flavor, sweet, nutty, tan color, and smooth mouthfeel.

After standing overnight at 4° C., the viscosity was measured as described above to be 95.4 cPs (average of 3 measurements). Moreover, the product turned green, although it had good flavor, and thick mouthfeel.

### Example 4: Composition Made Without Enzymatic Treatment and Chickpea Flour

Table 3 shows the dry blend components for the chickpea milk composition.

TABLE 3

| | | Wt % aqueous |
|---|---|---|
| | Wt % Dry | beverage plus |
| Component | Blend | plant based oil |
| Chickpea flour (about 60 wt % starch) | 12.76% | 1.2505% |
| Chickpea protein concentrate | 55.51% | 5.4400% |
| (about 60 wt % protein) | | |
| Soluble corn fiber dry | 25.51% | 2.5000% |
| Salt | 1.22% | 0.1196% |
| Gellan gum | 0.17% | 0.0167% |
| Sweetener | 0.14% | 0.0133% |
| Natural Milk Flavor | 0.51% | 0.0500% |
| Calcium Carbonate | 4.18% | 0.4096% |
| Vanillin (1% solution) | none | 1.46 |
| Flavor masker | none | 0.1 |
| Coconut oil | none | 1.46 |
| Water | none | Balance to 100% |

Results: After standing overnight at 4° C., the viscosity was measured as described above to be 65.53 cPs (Average of 3 replicates), which is considered thicker than desirable for milk. The beverage poured visually thicker than dairy milk, but had a smooth, thick mouthfeel. The chickpea flour-based composition was less viscous than the oat flour-based counterpart.

### Example 5: Composition Made With Enzymatic Treatment and Chickpea Flour

Table 4 shows the chickpea milk composition with enzymatic treatment made as described above. Note that the enzyme is added at 1.1 grams per kg of starch in the composition. This is the same composition as shown in Table 3, with added enzyme. 15 kg of the mixture contained about 138 grams starch.

TABLE 4

| | | Wt % (except for |
|---|---|---|
| | | enzyme) aqueous |
| | Wt % Dry | beverage plus |
| Component | Blend | plant based oil |
| Chickpea flour (about 62% wt starch) | 12.76% | 1.25% |
| Chickpea protein concentrate | 55.51% | 5.4400% |
| (about 60 wt % protein) | | |
| Soluble corn fiber dry | 25.51% | 2.50% |
| Salt | 1.22% | 0.12% |
| Gellan gum | 0.17% | 0.0167% |
| Sweetener | 0.14% | 0.0133% |
| Natural Milk Flavor | 0.51% | 0.0500% |
| Calcium Carbonate | 4.18% | 0.4096% |
| Vanillin (1% solution) | none | 1.46% |
| Flavor masker | none | 0.1% |
| Coconut oil | none | 1.46% |
| Alpha amylase | none | 0.15 gram (1.1 grams |
| | | per kg starch) |
| Water | none | Balance to 100% |

Results: The fresh product appeared visually thinner and was perhaps slightly sweeter than the fresh non-enzyme treated composition. After standing overnight at 4° C., the viscosity was measured as described above to be viscosity: 44 cPs (Average of 3 replicates). The beverage? provided an approximately 33% reduction in viscosity with enzymatic treatment compared to without the enzyme treatment. The composition had a smooth and thin mouthfeel and poured visually thinner than the non-enzyme-treated composition of Example 4. The composition contained 88.54% purified water; 5.44% chickpea protein concentrate (about 60% protein); 2.5% soluble corn fiber; 1.46% coconut oil; 1.25% chickpea flour; 0.41% calcium carbonate; 0.017% gellan gum; 0.001% enzyme; and flavors; salts; sweeteners as suitable to taste.

Given the complexity of the matrix formulation, numerous factors affect the beverage viscosity and mouthfeel for example. What was surprising was the extent to which this method altered the beverage viscosity properties, indicating that starch and the enzyme's hydrolysis of the starch, played a large role in determining viscosity of the composition.

1. A composition comprising:
a consumable liquid;
a source of starch optionally comprising at least one of chickpea flour, oat flour, or a combination thereof;
chickpea protein isolate, chickpea protein concentrate, or combination thereof, and optionally, at least one edible plant-derived lipid.

2. The composition of claim 1, further comprising an enzyme, wherein the enzyme is active or inactivated.

3. The composition of claim 2, wherein the enzyme is or was capable of hydrolyzing starch present in the source of starch into sugar.

4.-5. (canceled)

6. The composition of claim 1, wherein the source of starch comprises chickpea flour.

7. (canceled)

8. The composition of claim 2, wherein the enzyme comprises at least one amylase, or combination thereof.

9.-10. (canceled)

11. The composition of claim 1, comprising, by weight of the composition, from 0.05 to 10 wt % of chickpea protein present in the chickpea protein isolate, chickpea protein concentrate, or combination thereof and from 0.05 to 10 wt % of starch present in the source of starch;
wherein the composition has a viscosity of less than 60 cPs after standing for 12 hours at 4° C., as measured with a Brookfield DV2T Viscometer for beverages at 4° C., with spindle #1, readings taken after 30 seconds at 100 rpm, and torque in the range of 15-85%.

12.-13. (canceled)

14. A method of preparing a composition, comprising:
combining:
a consumable liquid optionally comprising water;
a source of starch, optionally comprising at least one of chickpea flour, oat flour, or a combination thereof;
optionally, at least one edible plant-derived lipid; and
chickpea protein isolate, chickpea protein concentrate, or combination thereof;
to provide a chickpea protein and starch composition having an enzymatically untreated viscosity, the enzymatically untreated viscosity being measured after standing for 12 hours at 4° C., as measured with a Brookfield DV2T Viscometer for beverages at 4° C., with spindle #1, readings taken after 30 seconds at 100 rpm, and torque in the range of 15-85%.

15. (canceled)

16. The method of claim 14, further comprising:
combining an enzyme with the chickpea protein and starch composition having an enzymatically untreated viscosity,
wherein the enzyme is capable of acting on starch present in the source of starch under enzymatic conditions to hydrolyze at least a portion of the starch present in the source of starch into sugar.

17. The method of claim 16, wherein the enzyme comprises at least one amylase or combination thereof.

18. The method of claim 16, further comprising:
allowing the enzyme to hydrolyze at least a portion of the starch present in the source of starch into sugar at the enzymatic conditions;
to provide a chickpea protein and starch composition having a reduced viscosity, the reduced viscosity being measured after allowing the enzyme to hydrolyze at least a portion of the starch into sugar and after standing for 12 hours at 4° C., as measured with a Brookfield DV2T Viscometer for beverages at 4° C., with spindle #1, readings taken after 30 seconds at 100 rpm, and torque in the range of 15-85%;
wherein the reduced viscosity is lower than the enzymatically untreated viscosity;
optionally, removing the consumable liquid; and
optionally, removing the enzyme.

19. The method of claim 18, wherein the reduced viscosity is 60 cPs or less, preferably 50 cPs or less.

20. (canceled)

21. The method of claim 18, further comprising:
deactivating the enzyme at deactivation conditions; and
optionally, removing the deactivated enzyme.

22. (canceled)

23. The method of claim 21, further comprising homogenizing the chickpea protein and starch composition.

24. The method of claim 14, further comprising:
removing the consumable liquid.

25. (canceled)

26. A composition comprising:
a source of starch optionally comprising at least one of chickpea flour, oat flour, or a combination thereof;
chickpea protein isolate, chickpea protein concentrate, or combination thereof; and
optionally, at least one edible plant-derived lipid.

27. The composition of claim 26, further comprising an enzyme, wherein the enzyme is active or inactivated.

28. The composition of claim 27, wherein the enzyme is or was capable of hydrolyzing starch present in the source of starch into sugar.

29. The composition of claim 27, wherein the enzyme comprises at least one amylase, or mixture thereof.

30. (canceled)

31. The composition of claim 26, wherein the source of starch comprises chickpea flour.

32.-34. (canceled)

35. The composition of any of claim 26, further comprising at least one consumable liquid, and comprising, by weight of the composition, from 0.05 to 10 wt % of chickpea protein present in the chickpea protein isolate, chickpea protein concentrate, or combination thereof and from 0.05 to 10 wt % of starch present in the source of starch;
wherein the composition has a viscosity of less than 60 cPs after standing for 12 hours at 4° C., as measured with a Brookfield DV2T Viscometer for beverages at 4° C., with spindle #1, readings taken after 30 seconds at 100 rpm, and torque in the range of 15-85%.

36.-37. (canceled)
